(19) United States
(12) Patent Application Publication
(10) Pub. No.: US 2013/0228613 A1
(43) Pub. Date: Sep. 5, 2013

(54) Method Of And System For Brazing Aluminum Workpieces Using A Flame And Monitoring Of The Flame Color

(71) Applicants: Timothy Andrecheck, Chittenango, NY (US); Mark R. Jaworowski, Glastonbury, CT (US); Lester J. York, Syracuse, NY (US)

(72) Inventors: Timothy Andrecheck, Chittenango, NY (US); Mark R. Jaworowski, Glastonbury, CT (US); Lester J. York, Syracuse, NY (US)

(73) Assignee: Carrier Corporation, Farmington, CT (US)

(21) Appl. No.: 13/885,728

(22) PCT Filed: Oct. 21, 2011
(86) PCT No.: PCT/US11/57192

§ 371 Date: May 16, 2013

Related U.S. Application Data
(60) Provisional application No. 61/415,411, filed on Nov. 19, 2010.

(51) Int. Cl. B23K 31/12

(52) U.S. Cl. CPC B23K 31/12
USPC 228/102; 228/8

(57) ABSTRACT

A method of brazing an assembly (202) having at least two aluminum workpieces coupled at a joint includes applying a flame to the joint of the aluminum workpieces; monitoring the flame color; and upon detecting a change in the flame color, maintaining a temperature at the joint.

### BACKGROUND OF THE INVENTION

The subject matter disclosed herein relates to brazing of workpieces, and more particularly, to a method and system for brazing aluminum workpieces.

Brazing is used to join metal workpieces by heating a joint of the workpieces (e.g., via a torch) and applying a filler to the joint once the workpieces have reached a suitable temperature. The filler melts into the joint, and when cooled creates a mechanical attachment between the workpieces.

Controlling heat during brazing can be challenging when working with certain materials. In aluminum brazing, it is hard to know when the workpiece is hot enough to apply the filler, as the aluminum workpiece does not undergo a color change when heated. Often, operators will melt and ruin the workpieces because they overheat and melt the joint. The brazing temperatures may be only 100-200 degrees away from the melting temperature of the workpiece, leaving operators with little margin for error in brazing aluminum. As such, improvements in brazing aluminum would be well received in the art.

### BRIEF DESCRIPTION

According to one aspect of the invention, a method of brazing an assembly having at least two aluminum workpieces coupled at a joint includes applying a flame to the joint of the aluminum workpieces; monitoring the flame color; and upon detecting a change in the flame color, maintaining a temperature at the joint.

According to another aspect of the invention, a system for brazing an assembly having at least two aluminum workpieces coupled at a joint includes a flame unit for applying a flame to the joint coupling the aluminum workpieces; an optical detection unit for monitoring the flame; a machine for controlling a relative position between the flame and the assembly; and a controller coupled to the flame unit and the machine, the controller controlling at least one of flame intensity and relative position of the flame and the assembly in response to the optical detection unit.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates brazing of workpieces in an exemplary embodiment;

FIG. 2 is a flowchart of a process of brazing workpieces in an exemplary embodiment;

FIG. 3 illustrates an automated brazing system in an exemplary embodiment; and

FIG. 4 illustrates an automated brazing system in another, exemplary embodiment.

The detailed description explains embodiments of the invention, together with advantages and features, by way of example with reference to the drawings.

### DETAILED DESCRIPTION OF THE INVENTION

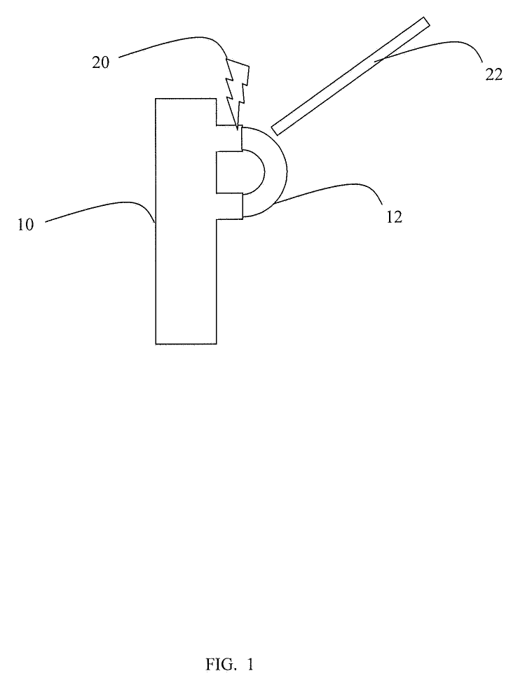

FIG. 1 illustrates brazing of workpieces in an exemplary embodiment. As shown in FIG. 1, an assembly includes workpieces 10 and 12 being joined by brazing. Workpiece 10 may be an aluminum heat exchanger body and workpiece 12 may be an aluminum u-shaped fitting. A flame 20 is applied to the joint of workpieces 10 and 12 until the joint reaches a heat sufficient to melt a filler material. The source of flame 20 may be torch using known fuel types (e.g., propane, oxy-acetylene, propylene, natural gas, MAPP, hydrogen, LP, acetylene). The fuel type may be any fuel-air/oxygen combination, which produces a blue type flame, in order to create a color change when used on aluminum as described herein. Once a suitable temperature is reached, filler material 22 is applied to the joint. Alternatively, filler mater can be pre-assembled into the joint as a ring, wire, foil or paste. The filler material melts into the joint between workpieces 10 and 12, and once cooled, secures the workpieces 10 and 12. Flux may be applied to the joint prior to applying heat, or the filler material 22 may include a flux coating or core.

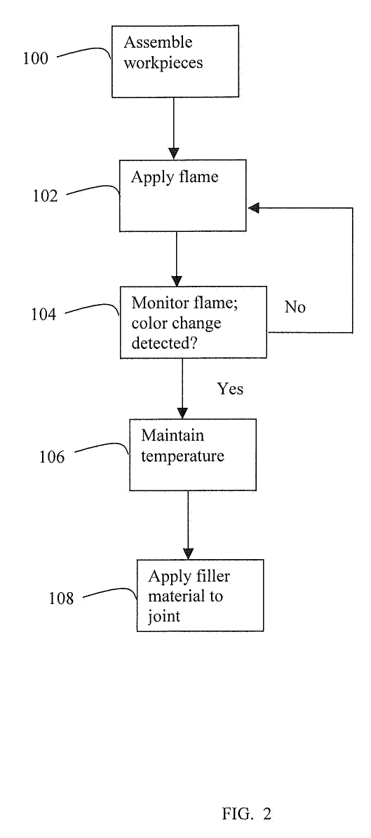

FIG. 2 is a flowchart of a process for brazing aluminum workpieces to prevent overheating, and destruction, of the workpieces. The process begins at 100 where the workpieces are assembled at a joint, such as the joint between workpieces 10 and 12 of FIG. 1. At 102, heat is applied to the joint by applying a flame to the joint. At 104, the color of the flame is monitored to detect a color change. Initially, the flame is blue-green in color. As the aluminum is heated, the absorption spectrum of the flame surrounding the aluminum workpieces shifts to absorb more of the green-blue color of the flame. This is perceived by the user as a shift in flame color to a red-orange color.

If at 104 no change in flame color is perceived, the process loops back to 102 and continues until a change in flame color is detected at 104. Once a change in flame color is detected, flow proceeds to 106 where the temperature at the joint is maintained, but not increased. This may be performed by physically moving the torch farther from the joint or reducing the intensity of the flame (e.g., by adjusting a knob on the torch). The color change indicates that the aluminum workpieces are at sufficient temperature to melt the filler. Reducing the heat at 106 prevents overheating of the joint and damaging the workpieces, while still maintaining the joint at a temperature sufficient to melt the filler material. At this stage, the filler may be applied to the joint at 108.

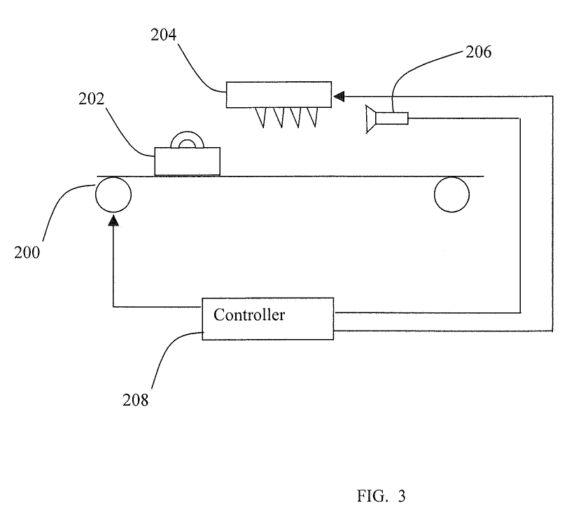

FIG. 3 depicts an automated brazing system in exemplary embodiments. The system includes a machine 200 in the form of a conveyer for transporting assembly 202. The assembly 202 includes filler material (e.g., ring, wire, foil or paste) positioned at a joint between the two aluminum workpieces. A flame unit 204 applies a flame to the assembly to heat the joint to a temperature to melt the filler material. An optical detection unit 206 monitors the flame and provides output to controller 208. The optical detection unit 206 may be a camera generating images or a spectrometer generating spectra of the flame. The output of the optical detection unit 206 is provided to controller 208.

Controller 208 processes the output from optical detection unit 206 to control the conveyor 200 and/or the flame unit 204. Controller 208 may be a general-purpose microprocessor based controller, executing the processes described herein in response to instructions stored in a computer-readable storage medium. If the optical detection unit 206 is a camera, the controller 208 detects a color shift from blue-green to red-orange using image processing. For example, the pixel values (e.g., RGB, HSL, HSV, HSI) from the pixels in the image can be compared to known red-orange pixel values to detect the color shift. If the optical detection unit 206 is a spectrometer, the controller can detect a decrease in the intensity of known wavelengths complementary to red-orange wavelengths, either as an absolute measurement of intensity, or relative to spectral bands where absorption effects do not take place.

Controller 208 provides control signals to the conveyor 200 and/or the flame unit 204 in response to the output of optical detection unit 206. If the color shift has not occurred within a predetermined amount of time, controller 208 can adjust the relative position between the flame and the assembly 202 by slowing the conveyor 200. Further, controller 208 may increase the intensity of the flame from flame unit 204. Once the color change is detected by controller 208, controller 208 can increase the speed of conveyor 200 to adjust relative position between the flame and the assembly 202 and/or reduce the intensity of the flame from flame unit 204. This maintains the temperature at the joint. The color change indicates that the assembly 202 has reached the appropriate temperature to melt the filler material. Reducing the heat prevents overheating of the joint and damaging the workpieces, while still maintaining the joint at a temperature sufficient to melt the filler material. In this manner, the controller 208 prevents damage to the aluminum assembly 202.

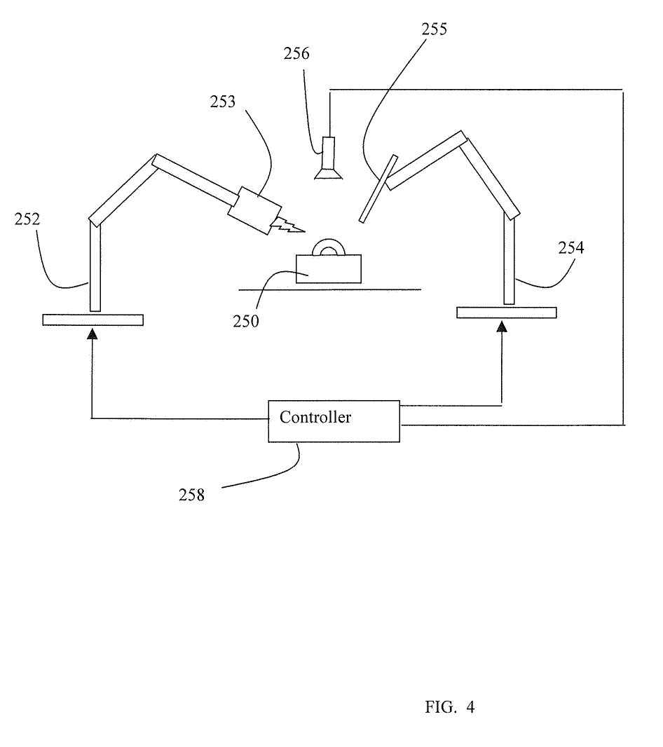

FIG. 4 depicts an automated brazing system in exemplary embodiments. An assembly 250 to be brazed includes two aluminum workpieces connected at a joint as described above. A first machine 252 includes a flame unit 253 generating the flame to be applied to assembly 250. Flame unit 253 may be electronically controllable to adjust the flame intensity. Machine 252 may be a robotic arm, or other device capable of electronically controlled motion in three dimensions. Machine 254 manipulates the filler material 255 (e.g., a rod of filler material) to place the filler material 255 at the joint. Machine 254 may be a robotic arm, or other device capable of electronically controlled motion in three dimensions. In alternate embodiments, the joint is pre-packed with filler material, and machine 254 is not utilized. An optical detection unit 256 monitors the flame and provides output to controller 258. The optical detection unit 256 may be a camera generating images or a spectrometer generating spectra of the flame.

Controller 258 processes the output from optical detection unit 256 to control machines 252 and 254. If the optical detection unit 256 is a camera, the controller 258 detects a color shift from blue-green to red-orange using image processing. For example, the pixel values (e.g., RGB, HSL, HSV, HSI) from the pixels in the image can be compared to known red-orange pixel values to detect the color shift. If the optical detection unit 256 is a spectrometer, the controller 258 can detect a decrease in the intensity of known wavelengths complementary to red-orange wavelengths, either as an absolute measurement of intensity, or relative to spectral bands where absorption effects do not take place.

Controller 258 provides control signals to machines 252 and 254 in response to the output from optical detection unit 256. If the color shift has not occurred within a predetermined amount of time, controller 258 can position machine 252 to alter the relative position between the flame and the assembly 250 by moving the flame closer to the assembly 250. Controller 258 may also increase the intensity of the flame produced at flame unit 253. Once the color change is detected by controller 258, controller 258 maintains the temperature at the join. Controller 258 may alter the relative position between the flame and the assembly 250 by moving the flame farther from the assembly 252. Controller 258 may also reduce the intensity of the flame from flame unit 253, as the color change indicates that the assembly 250 has reached the appropriate temperature to melt the filler material. Maintaining the temperature prevents overheating of the joint and damaging the workpieces, while still maintaining the joint at a temperature sufficient to melt the filler material. Once the color shift is detected, controller 258 commands machine 254 to place the filler material in contact with the joint on assembly 250 to perform the brazing. As noted above, if the joint is pre-packed with filler material, and machine 254 is not utilized.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of brazing an assembly having at least two aluminum workpieces coupled at a joint, the method comprising:
applying a flame to the joint of the aluminum workpieces;
monitoring the flame color; and
upon detecting a change in the flame color, maintaining a temperature at the joint.

2. The method of claim 1 further comprising:
applying a filler material to the joint upon detecting the change in the flame color.

3. The method of claim 1 wherein:
maintaining the temperature at the joint includes moving the flame away from the assembly.

4. The method of claim 1 wherein:
maintaining the temperature at the joint includes reducing the intensity of the flame.

5. The method of claim 1 wherein:
detecting the change in flame color includes detecting a shift from blue-green to red-orange.

6. A system for brazing an assembly having at least two aluminum workpieces coupled at a joint, the system comprising:
a flame unit for applying a flame to the joint coupling the aluminum workpieces;
an optical detection unit for monitoring the flame;
a machine for controlling a relative position between the flame and the assembly; and
a controller coupled to the flame unit and the machine, the controller controlling at least one of flame intensity and relative position of the flame and the assembly in response to the optical detection unit.

7. The system of claim 6 wherein:
the machine is a conveyor belt moving the assembly past the flame unit, the controller adjusting the speed of the conveyor belt in response to the optical detection unit.

8. The system of claim 7 wherein:
the controller detects a color change in the flame.

9. The system of claim 8 wherein:
the color change is shift from a blue-green color to a red-orange color.

10. The system of 9 wherein:
the controller increases the speed of the conveyor belt upon detecting the color change.

11. The system of 9 wherein:
the controller decreases the intensity of the flame upon detecting the color change.

12. The system of claim 6 wherein:
the flame unit is mounted to the machine, the controller controlling the machine to adjust a three dimensional location of the flame unit in response to the optical detection unit.

13. The system of claim 12 wherein:
the controller detects a color change in the flame.

14. The system of claim 13 wherein:
the color change is shift from a blue-green color to a red-orange color.

15. The system of 14 wherein:
the controller controls the machine to increase the distance between the flame unit and the assembly upon detecting the color change.

16. The system of 14 wherein:
the controller controls the flame unit to decrease the intensity of the flame upon detecting the color change.

17. The system of claim 6 wherein:
the optical detection unit is a camera.

18. The system of claim 17 wherein:
the controller detects the color change by comparing pixel values in the output of the optical detection unit to red-orange pixel values.

19. The system of claim 6 wherein:
the optical detection unit is a spectrometer.

20. The system of claim 19 wherein:
the controller detects the color change by detecting a decrease in an intensity of wavelengths complementary to red-orange wavelengths, the decrease being measured as at least one of (i) an absolute measurement of intensity or (ii) a measure relative to spectral bands where absorption effects do not take place.
